(19) United States
(12) Patent Application Publication
(10) Pub. No.: US 2013/0332132 A1
(43) Pub. Date: Dec. 12, 2013

(54) COMPUTERIZED METHOD FOR THE ESTIMATION OF A VALUE FOR AT LEAST A PARAMETER OF A HYDROCARBON-PRODUCING REGION, FOR PLANNING THE OPERATION AND OPERATING THE REGION

(71) Applicants: Vincent Mongalvy, Pau (FR); Lu Lu, Pau (FR); Satish Agarwal, Pau (FR)

(72) Inventors: Vincent Mongalvy, Pau (FR); Lu Lu, Pau (FR); Satish Agarwal, Pau (FR)

(73) Assignee: TOTAL SA, Courbevoice (FR)

(21) Appl. No.: 14/000,743

(22) PCT Filed: Feb. 23, 2011
(86) PCT No.: PCT/IB2011/000773

§ 371 Date: Aug. 21, 2013

(51) Int. Cl. G06F 17/50

(52) U.S. Cl. CPC G06F 17/5009
USPC 703/10

(57) ABSTRACT

A method for the estimation of a value for an investigated parameter of a hydrocarbon-producing region, comprising: a) using a design of experiments tool to determine a ruling law for a match parameter as a function of descriptive parameters, b) conducting a set of experiments using a simulation tool wherein, for each experiment, the region is geometrically and physically modelled, c) determining suitable sets of values for descriptive parameters from the ruling law, and d) determining a value for the investigated parameter from most likely sets of values.

### PRIORITY CLAIM

The present application is a National Phase entry of PCT Application No. PCT/IB2011/000773, filed Feb. 23, 2011, said application being hereby incorporated by reference herein in its entirety.

### FIELD OF THE INVENTION

The instant invention relates to computerized methods for the estimation of a value for at least a parameter of a hydrocarbon-producing region (in particular a shale gas region), for planning the operation and operating the region.

### BACKGROUND OF THE INVENTION

Shale gas is natural gas produced from shale. It has become an increasingly important source of natural gas in the world and is expected to greatly expand the worldwide energy supply.

Because shale has a low matrix permeability, commercial gas production from these regions requires artificial fracturing to provide permeability. This leads the commercial operation of the region to be subject to very complex and competing physical phenomena. Proper operation of these regions would require extensive simulation work based on very sparse data or knowledge.

This is illustrated for example by Freeman et al., “A numerical study of Performance for Tight Gas and Shale Gas Reservoir Systems”, SPE 124961. In Table 2, 24 cases are computed, varying 3 parameters, namely fracture spacing (10, 20, or 25 m), fracture width (1, 0.1, 0.01 or 0.001 mm), and Langmuir volume (0, 50, 100, 200 or 400 scf/ton).

Hence, very few parameters were investigated, and very few different values for these parameters were tried, with extensive calculation work. Complex phenomena such as that occurring for shale gas operation, can not be modelled with such simple approaches.

The object of the present invention is to improve the accuracy of the estimation of the region, with reduced computer time.

### SUMMARY OF THE INVENTION

To this aim, according to the invention, provided is a computerized method for the estimation of a value for at least an investigated parameter of a hydrocarbon-producing region, said region being describable by a plurality of descriptive parameters, wherein the method comprises:

a) using a design of experiments tool to determine a ruling law for a match parameter as a function of said plurality of descriptive parameters, based on a set of experiments conducted for a selected group of sets of values for said plurality of descriptive parameters,

b) conducting said set of experiments using a simulation tool wherein, for each set of values of the selected group, the region is geometrically and physically modelled, and a value for said match parameter for this group is estimated with the simulation tool,

c) determining suitable sets of values for said plurality of descriptive parameters from the ruling law, and

d) determining said value for at least an investigated parameter from said suitable sets of values.

With these features, an exhaustive screening of the parameters is performed, and an accurate estimation can be obtained.

The above method is useful when values of some of the governing parameters are unknown, and where non-uniqueness of solution is possible.

In some embodiments, one might also use one or more of the features as defined in the dependant claims.

According to another aspect, the invention relates to a computerized method for the planning of the operation of a hydrocarbon-producing region, comprising generating a reservoir model of the region.

According to another aspect, the invention relates to a method of operation of a hydrocarbon-producing region, comprising producing hydrocarbons from the region.

According to another aspect, the invention relates to a computer program product comprising instructions causing a programmable machine to execute steps of the method, when the computer program product is loaded in the programmable machine.

### BRIEF DESCRIPTION OF THE DRAWINGS

Other characteristics and advantages of the invention will readily appear from the following description of one of its embodiments, provided as a non-limitative example, and of the accompanying drawings.

On the drawings:

FIG. 1 is a schematic perspective view of a shale gas region,

FIG. 2 is a schematic sectional view in the shale gas region of a horizontal well with associated propped highly conductive fracture plan,

FIG. 3 is a schematic view showing the interaction between a design of experiment tool and a simulation tool,

FIG. 4 is an exploded perspective view of a mesh used with the simulation tool,

FIG. 5 is a graph comparing a simulated match parameter and experimental data,

FIG. 6 is a diagrammatic chart of a process according to an embodiment, and

FIG. 7 is a schematic perspective view of a computerized system used to implement the process.

On the different Figures, the same reference signs designate like or similar elements.

### DETAILED DESCRIPTION OF THE FIGURES

FIG. 1 schematically shows a region 1 for which the invention can be implemented. The region 1 comprises a ground 2 as well as a plurality of underground strata 3a, 3b, 3c, 3d, etc. At least one of these strata is a hydrocarbon-producing region. In a particular embodiment of the invention, this region is a shale region. Although the invention is described below with reference to shale regions, the invention may be applied to other kinds of hydrocarbon-producing regions, in particular when many parameters and physical phenomena influence the overall characteristics of hydrocarbon production from this region.

As shown on FIG. 1, a well 4 is provided in the region 1. A drill 5 is provided, which extends from the well 4 into the shale stratum 3b. In particular, the drill 5 extends horizontally or close to the horizontal in the shale stratum 3b.

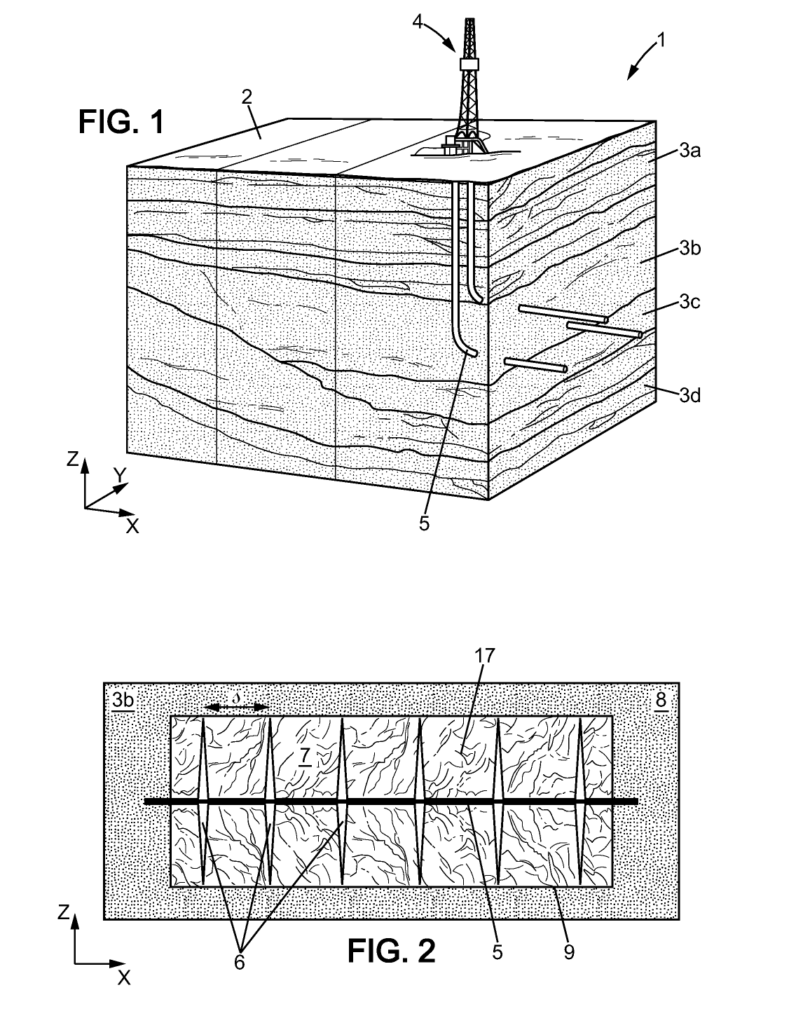

A small part of the shale 3b is shown on FIG. 2. FIG. 2 shows the drill 5, which extends schematically horizontally, as well as three distinct zones of the shale.

In the actual region, there is a continuous evolution of the characteristics of the artificial fractures from the nearby well all the way to a rock volume totally unaffected by the stimulation. For simulation purposes, it is difficult to reproduce this unknown continuous evolution. One may use a discrete representation using sets of propped artificial fractures, and a network of unpropped or slightly propped fractures as described below

In a first zone, artificial fractures 6 are present. These fractures are for example provided by artificially propping fractures in the shale, for example using water and/or sand or the like. Propped fractures 6 are filled with sand or the like. Each fracture extends about a plane normal to the extension of the drill 5 and to a given distance from the drill 5. It is rather thin compared to the other dimensions of the system, and can be approximated as surface. A given spacing s between two subsequent fractures along the drill 5 can be provided as regular, or not, depending on the cases.

In a second zone, the rock volume 7 which surrounds the area containing the highly conductive propped fractures 6 is called the effective stimulated rock volume, or ESRV. It comprises—unpropped or slightly propped—artificial fractures, and possibly unpropped or slightly propped reactivated natural fractures.

In a third zone, the rock volume 8 outside the ESRV is called the unstimulated rock volume, or USRV. The USRV can be considered as a matrix of rock where no artificial fractures extend. A virtual border 9 delimits the ESRV from the USRV.

The production of hydrocarbons from the region is believed to be governed at least by the following descriptive parameters (natural and/or engineered):
storativities, including storativity of the adsorbed gas in the ESRV and USRV matrix, storativity of the free gas in the USRV, and storativity of the free gas in the ESRV (porosities),
conductivities, including permeability of the matrix, permeability of the network (unpropped) fractures and permeability of the highly conductive propped fracture set, and
exchange capacities between network fractures and the matrix, the network fractures and the propped fracture sets, the matrix and the propped fracture sets, the ESRV and the USRV, including adsorption/diffusion dynamics within the matrix, depending on the block size of the unpropped fracture network, and the surface of the propped hydraulic fractures.

Such parameters may be used directly, or a different set of parameters may be used, for example based on different combinations of the above parameters.

The knowledge of the range of values which can be taken for these different parameters varies greatly among the parameters. Value intervals for these parameters may be rather broad or narrow. Some of the parameters may for example be determined experimentally, by performing tests and/or experiments in laboratories. This is for example the case for the permeability of the matrix (KMTX) and the storativity of the adsorbed gas (VL).

Intervals for some other parameters may be determined, for example, from the scientific literature. This is for example the case for the permeability of the propped fractures (KHF).

Some other intervals may be determined by analysis of the region, such as for example, using micro-seismic mapping, such as for example the stimulated rock volume to estimate the Effective Stimulated Rock Volume (ESRV) and/or the propped hydraulic fracture surface (HFSZ).

Yet, some other intervals may be difficult to determine using experimental data. This is for example, the case for the storativity of the unstimulated zone (GRV), the permeability of the unpropped fracture (KMF), the adsorption/diffusion dynamics (DYN), the unpropped fracture network block size (σ), the unpropped network fracture permeability impairment function with overburden pressure (RTNF), and the highly conductive propped fracture permeability impairment function with overburden pressure (RTHF). Yet, some constraints may be used to limit the size of these intervals, such as, for example, for the storativity of the unstimulated zone, the spacing of the wells, or for the fracture sizes, the volumes of injected sand and water.

Petrophysical and/or dynamic data may be used to determine the intervals.

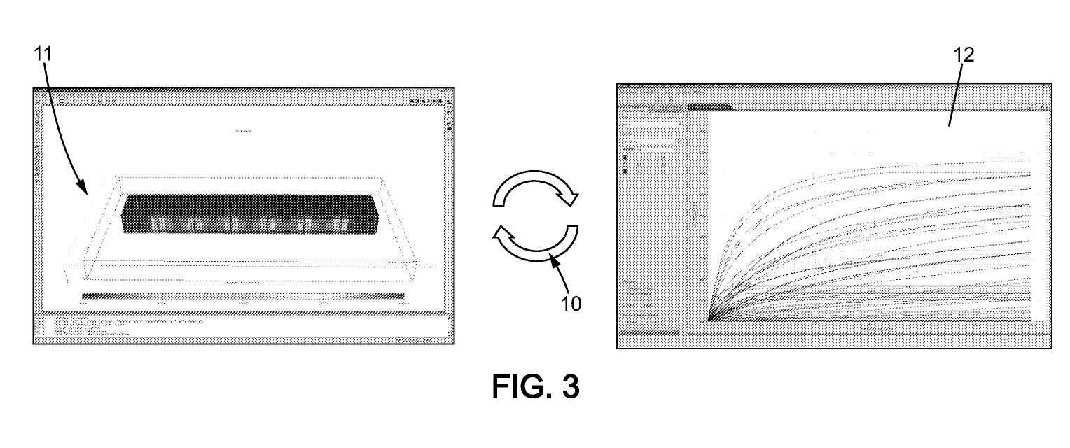

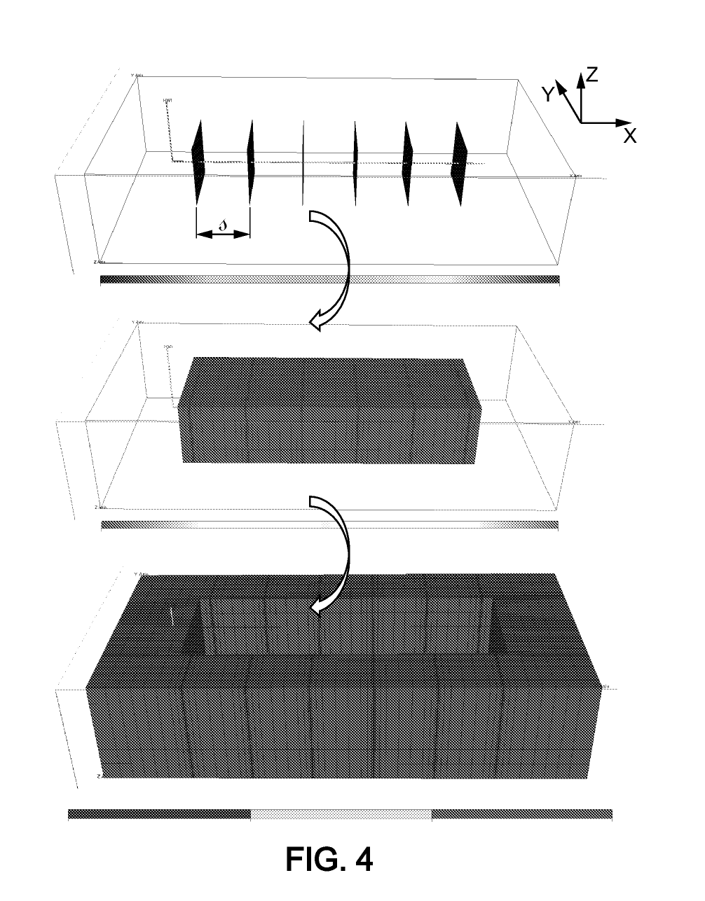

Turning now to FIG. 3, one embodiment of the method uses a coupling 10 between a simulation tool 11 and a design of experiment tool 12. Both tools 11, 12 are for example software tools, whereby the method can be computerized, as will be explained below in relation to FIG. 7.

The simulation tool 11 is a tool which enables to perform a simulation of the production of hydrocarbons for a region defined by a set of values for the above parameters and/or other parameters to be defined as variables as needed. In particular, in the simulation tool, for a set of values of the above descriptive parameters, a region corresponding to these parameters is geometrically and physically modelled, and a value for a match parameter can be estimated for this region. The match parameter is, for example, a quantity of gas produced for the modelled region between an initial time T₀ and a final time T_{f}. However, the match parameter needs not necessarily be a value, but may also be a function, such as for example, a function of time, such as in particular, a production quantity for this region as a function of time.

The design of experiment tool 12 is a tool enabling to define a set of experiments to be conducted, and to determine a ruling law for a match parameter as a function of the descriptive parameters identified above. Each of the experiments consist in electing a value for each of the above parameters and for this set of values, performing as an experiment, a simulation using the simulation tool 11 for these parameter values.

For example, the design of experiments tool 12 may define the match parameter MP as being a function f of the descriptive parameters as listed above. In particular, the design of experiments tool may consider the following equation:

MP=f(P₁, . . . ,Pₙ).

f can for example be a polynomial function, of a given degree, for example a degree 2, meaning that the above equation can be written:

MP=a₀+a₁P₁+ . . . +aₙPₙ+a₁₁P₁²+a₁₂P₁P₂+ . . . +aₙₙPₙ²

The function f is totally defined by a set of K weights a₀, a₁, . . . , aₙₙ. Hence, for this linear system, performing a limited number of experiments would enable to determine these weights.

The choice of the experiments to be conducted and the determination of the parameters of the ruling law are classically performed by the design of experiment tool 12. For example, after conducting K experiments, a linear system with K equations and K unknowns (the weights) may be solved by any suitable method.

The design of experiment tool 12 may further comprise statistic analysis tools such as Pareto tools and the like.

FIG. 4 shows in more detail a geometrical model used for the simulation tool 11. In this particular example, the three different areas 6, 7 and 8 are modelled with three different geometrical models. When running the simulation tool, these three models are superimposed. The first model on the top of FIG. 4 is a model of the highly conductive propped fractures 6. This model is characterized by the width of the fractures, as well as the exchange surface with the stimulated block volume (HFSZ). The hydraulic permeability of the fractures (KHF) is a further parameter of these fractures as well as their porosity.

As shown in the middle of FIG. 4 a second modelled medium is the effective stimulated rock volume (ESRV). Parameters of the ESRV are its volume itself (ESRV), constrained by the micro seismic data, the permeability of the matrix (KMTX), the permeability of the unpropped fracture network (KNF) and the density of the fractures (σ). It is for example assumed that this volume is a single connected volume, so as to simplify the process.

As visible on the lower part of FIG. 4, another modelled region is the unstimulated rock volume (USRV) which receives the ESRV. It is also defined by its volume (GRV), and by the matrix permeability which, likely, is the same matrix permeability as that of the stimulated rock volume matrix.

The simulation tool is able to determine a value for the match parameter based on the above input.

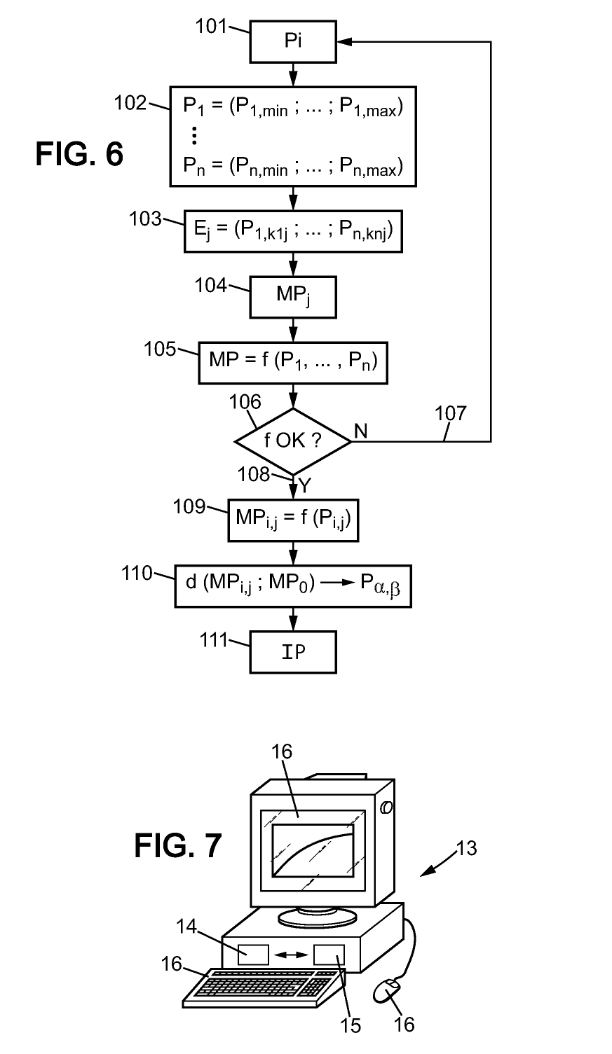

FIG. 6 now schematically shows a flow chart of an embodiment of the process using the above tools.

At step 101, the parameters Pᵢ which will govern the behaviour of the region are identified. These parameters are for example the parameters listed above, or combinations of these parameters, or only some of these parameters, if some others are considered as irrelevant for the present study. Another option is to use parameters which the above parameters are combinations of For example, injected water volume (V_{H2O}), injected sand volume (V_{Sand}), the size of grid cells used to discretize the propped fractures (S_{fracgrid}), the reservoir thickness (Hᵣₑₛ), the initial fracture water saturation (SW), fracture network porosity (phiNF), fracture aperture (Delta F), ESRV, can be used.

At step 102, intervals are determined for each parameter. For example, for a parameter P₁, it is determined that the value for the actual region is likely to extend in the interval [P_{1,min}; P_{1,max}]. The intervals are determined as explained above, for example based on experimental or previously available data, and can be either very narrow, if a good knowledge of the parameter is present, or very wide, if the parameter has a totally unknown value. Some of the parameters may be boolean, whereby the interval is [0;1].

Below, in Table 1, is an example of possible starting intervals:

TABLE 1

| | Nr of values in | | | |
|---|---|---|---|---|
| Parameter | interval | Min value | Max value | Scale |
| KMTX | 3 | 2 · 10⁻⁵ | 5 · 10⁻⁴ | Log |
| KHF | 3 | 200 | 20000 | Log |
| KNF | 3 | 0.001 | 0.1 | Log |
| SIGMA | 3 | 0.001 | 12 | Log |
| RTNF | 3 | Function low | Function high | Discrete |
| RTHF | 3 | Function low | Function high | Discrete |
| VL | 3 | 1 | 3 | Linear |
| GRV | 3 | 1 | 3 | Linear |

Further, the intervals may be discretized into discrete values. Hence, a number of possible discrete values are defined for each parameter, between the minimum and the maximum values. These discrete values may be discretized using a regular scale, a logarithmic scale, or as judged necessary, taking into account the nature of the parameter, such as functions of other variables calculated by or supplied to the simulator. Further, the number of possible discrete values for different intervals may be different.

The discrete values may also be functions, such as, for example for RTNF and RTHF, which are functions of the overburden pressure.

At step 103, the design of experiments tool 12 is used to define a group of experiments Eⱼ. Each experiment comprises each parameter Pu taking a discrete value P_{u,kuj} chosen in the above intervals. Hence, as shown on FIG. 6, the experiment Ej can be defined by a set of values, and written as Eⱼ={P_{1,klj}; . . . , P_{n,knj}}. The experiments are chosen so as to be able to determine the ruling law f of the match parameter as a function of the descriptive parameters.

At step 104, each experiment Eⱼ is performed using the simulation tool 11. This means that, for each experiment Eⱼ, a region is modelled as explained above in relation to FIG. 4, and the simulation tool determines the match parameter MPⱼ for this experiment. For example, the match parameter corresponds to the gas production for the modelled region after six months of production.

At step 105, the results of the above simulations are input again in the design of experiments tool 12 so as to determine the ruling law f of the match parameter as a function of the descriptive parameters P₁; . . . ; Pₙ. In other words, in the above example, the weights a₀, a₁, . . . aₙₙ are determined based on the above simulations.

At step 106, it is determined whether the function f determined at step 105 is accurate enough. In other words, it is determined whether f can reliably be used to predict the outcome of the simulation tool for a given set of parameter values. This can be determined by comparing the match parameter as calculated by the simulation tool for each experiment and the value of the match parameter provided by f for the respective set of values.

Comparison of the reliability of f with a predetermined threshold is performed. Alternatively, this can be performed as follows: The function f is applied to the exhaustive set of parameter values defined at step 102, and the value of MP is calculated for each of these combinations, based on the function f. These calculated values for MP are compared with experimental data or predictive data for the production region. For example, if the match parameter MP corresponds to the production of the region after six months, and if the actual production of the region after six months is known, the known value is compared to the cloud of calculated values. If the distance between the known values and the calculated values is too high (for example, if too few calculated values are within a predetermined distance from the known value), it is determined that the function f is maybe not accurate enough, and the process may move back along arrow 107. If the function f is judged accurate, the process will continue along arrow 108. By “distance”, it is meant any mean enabling to estimate the accuracy of the simulated result with respect to the experimental or predictive data of reference.

If the function f is judged unreliable (arrow 107), the process moves back to step 101, where the ruling parameters may be redefined. For example, it may be considered that one or more of the parameters initially elected are not relevant to the present study, or give inaccurate results. Pareto plots may be used to rule out parameters. For example, the USRV may be disregarded. At step 102, the intervals may also be redefined. For example, if the function f is judged not reliable enough, it may be considered that the intervals were not broad enough, and a new run may be implemented using broader intervals. For other parameters, it may also be understood that the intervals were too broad, and that the new run would be performed on a narrower interval, enabling to test more precise values for each parameter. Also, different scenarii for one parameter can be implemented. One parameter can first be set into a first sub-interval to implement the above process. Then, the same process is performed separately for a second different sub-interval. Thus, a function f is provided for each sub-interval. This process may be continued until one of the functions f is judged satisfactory (reliable) at step 106.

In the above example, the function f is determined for a time of production of for example six months. Hence, the weights of f are the weights for t=6 months.

Of course, the above process can be performed for other times t, since the simulation will anyway provide values for the match parameter along time MP(t). Repeating the above process for other time points will enable to define the weights as functions of time. This is shown for example on the right side of FIG. 3, where an exhaustive screening of the intervals was performed and the production as a function of time displayed on screen. Actual production data is shown by dots.

Hence, one goal of the step 107 is also to obtain a more accurate specification of each interval.

When f is judged satisfactory/reliable, moving along the arrow 108, one proceeds to step 109, where for the determined intervals which enabled to define f, one performs an exhaustive screening, and calculates the value MPᵢⱼ, of the match parameter for each combination of values of the parameters of these intervals, using the function f. This is performed with low resources, since it only involves calculating values of a polynomial or simple function.

At step 110, suitable sets of values P_{α,β} are determined from the values MPᵢⱼ determined at step 109. For example, a given set of sets of values for the parameters (for example the 50 best sets of values are said suitable) which provide a value MP_{i,j} closest to the known value MP₀ will be selected at step 110. Hence, at step 110, one has identified, based on an exhaustive screening of the parameters, the fifty best sets of parameter values for describing the region of interest. This step does not involve any probabilistic approach.

Below, in Table 2, the 3 best results as displayed in the design of experiment tool are described:

TABLE 2

| Rank | ESRV | KHF | KNF | RTNF | RTHF | Error |
|---|---|---|---|---|---|---|
| 1 | 0.263 | 0.973 | −0.942 | 1 | −0.235 | 0.99 |
| 2 | 0.260 | 0.973 | −1 | 0.9 | −0.135 | 0.985 |
| 3 | 0.275 | 0.95 | −0.94 | 0.8 | −0.535 | 0.95 |

Of course, this list can be continued up to the least relevant results.

The values for all parameters can be scaled between −1 and 1, as shown, where −1 corresponds to the minimum value and +1 to the maximum value of the interval.

At step 111, a value for an investigated parameter is determined based on said suitable sets of values determined at step 110. For example, this value is determined using the simulation tool 11. The sets of parameters Pα,β can be considered as input for the simulation tool and a simulation can be conducted using the simulation tool, using these values for the parameters. For example, the investigated parameter is a parameter which is not used in the above process (steps 101 to 110). It may be an estimation of the production volume of the region in the far future, for example 30 or 100 years from the start of the production.

The simulation tool can be used, as explained above, to estimate the quantity of production after a few months so as to compare the results of the simulation with existing data. However, the simulation tool can be used to continue the simulation, so as to estimate, for the regions modelled with the sets of values determined at step 110, the amount of production after a longer period, for example 30 years.

This value will be estimated by statistical analysis of the results of the simulations performed for each of the suitable sets of values, elected at step 110. The investigated parameter may not only be an estimation of the gas to be produced from the region, but could also for example be an estimation of the level of the uncertainty of the production of gas from this volume, production of associated water, or production of associated oil. The dispersion of the suitable sets of values determined at step 110, and/or the dispersion of the results of the simulation tool applied to the selected values at step 111 may determine the level of uncertainty for this produced volume.

A decision to operate the region can thus be based on the above simulation.

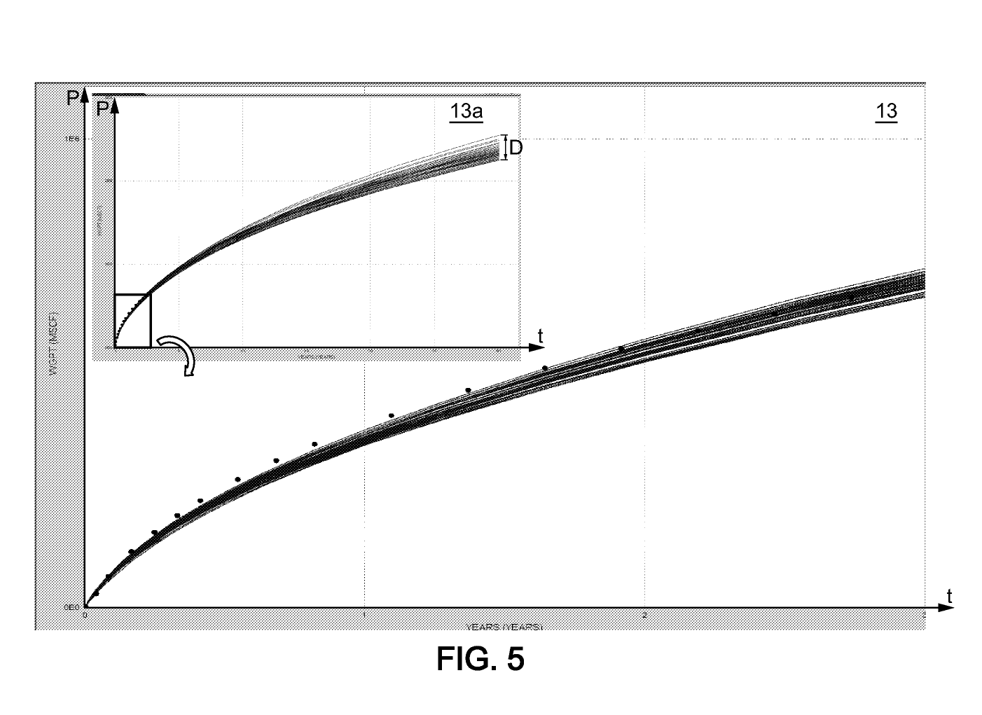

Referring to FIG. 5, the small window 13a describes the production P as a function of time t. Each curve corresponds to an estimation of P, using the simulation tool for the elected sets of parameters values. In the big window 13b, the dots correspond to actual production data for the three first years. D shows the dispersion of the results at thirty years.

Having thus determined descriptive parameters for the region, these parameters can be used for the planning of the operation of the region. These parameters can be introduced in a reservoir model of the region, so as to plan its operation by placing wells at suitable locations. Based on this planning, hydrocarbons can be produced.

FIG. 7 shows a computerized system 13 enabling to perform embodiments of the above process. The computerized system may in particular comprise a processor 14 which is able to run a computer program comprising the design of experiments tool and the simulation tool. A memory 15 can be used to store input data for the computer program, or to store data as results of these programs. The computerized system 13 may further comprise interface means 16 such as keyboard, mouse, or screen enabling to input data or read data outputs from the memory. The programs may be operated separately from one another, and communicate with one another using any suitable means, such as through a network of processing units or the like.

The embodiments above are intended to be illustrative and not limiting. Additional embodiments may be within the claims. Although the present invention has been described with reference to particular embodiments, workers skilled in the art will recognize that changes may be made in form and detail without departing from the spirit and scope of the invention.

Various modifications to the invention may be apparent to one of skill in the art upon reading this disclosure. For example, persons of ordinary skill in the relevant art will recognize that the various features described for the different embodiments of the invention can be suitably combined, un-combined, and re-combined with other features, alone, or in different combinations, within the spirit of the invention. Likewise, the various features described above should all be regarded as example embodiments, rather than limitations to the scope or spirit of the invention. Therefore, the above is not contemplated to limit the scope of the present invention.

1. A computerized method for the estimation of a value for at least an investigated parameter of a hydrocarbon-producing region, said region being describable by a plurality of descriptive parameters, wherein the method comprises:
a) using a design of experiments tool to determine a ruling law for a match parameter as a function of said plurality of descriptive parameters, based on a set of experiments conducted for a selected group of sets of values for said plurality of descriptive parameters,
b) conducting said set of experiments using a simulation tool wherein, for each set of values of the selected group, the region is geometrically and physically modelled, and a value for said match parameter for this group is estimated with the simulation tool,
c) determining suitable sets of values for said plurality of descriptive parameters from the ruling law, and
d) determining said value for at least an investigated parameter from said suitable sets of values.

2. The computerized method according to claim 1, wherein step d) comprises conducting an experiment using said simulation tool for at least one of said suitable sets of values, and determining said value for at least an investigated parameter as a result of said experiment.

3. The computerized method according to claim 1, wherein said investigated parameter is a level of an uncertainty of another parameter, wherein step d) comprises estimating said level of uncertainty based on a dispersion of said suitable sets of values.

4. The computerized method according to claim 1, wherein at step a), screening intervals are defined for each descriptive parameter, and wherein said group is selected inside these intervals.

5. The computerized method according to claim 4, further comprising performing at least once:
modifying the intervals, and repeating steps a) and b) for modified intervals.

6. The computerized method according to claim 4, wherein discrete values are listed in each interval, and wherein, at step c), said ruling law is applied to an exhaustive combination of these discrete values.

7. The computerized method according to claim 4, wherein at least some of said intervals are determined at least based on at least one of the following inputs:
petrophysical data for the region,
micro-seismic data for the region,
dynamic data for the region.

8. The computerized method according to claim 1, wherein, at step c), suitable sets of values are determined by comparing measured or predictive data (MP0) for the region to estimations of values obtained from the ruling law.

9. The computerized method according to claim 1, wherein the descriptive parameters comprise natural and engineered parameters of the region.

10. The computerized method according to claim 1, wherein the hydrocarbon-producing region is a shale hydrocarbon reservoir comprising the three following zones:
propped fractures,
an outer Unstimulated Rock Volume,
an internal Effective Stimulated Rock Volume, comprising unpropped or slightly propped network fractures,
and wherein the unstimulated Rock Volume is modelled at step b).

11. The computerized method according to claim 10, wherein the descriptive parameters include the storativity, conductivity and permeability impairment with overburden pressure of each zone, and exchange capacities between the respective zones.

12. The computerized method according to claim 11, wherein descriptive parameters are chosen among:
a surface area of the propped fractures,
a permeability of the propped fractures,
a volume of the Effective Stimulated Rock Volume,
a permeability of matrix in the Effective Stimulated and Unstimulated Rock Volume,
a permeability of fractures in the Effective Stimulated Rock Volume,
a density of fractures in the Effective Stimulated Rock Volume,
a volume of the Unstimulated Rock Volume,
a storativity of the adsorbed gas,
dynamics of the diffusion/adsorption,
a network fracture permeability response to variations of overburden pressure,
a propped fracture permeability response to variations of overburden pressure,
or combinations of these parameters.

13. A computerized method for the planning of the operation of a hydrocarbon-producing region, comprising:
applying the method according to claim 1,
generating a reservoir model of the region.

14. A method of operation of a hydrocarbon-producing region, comprising:
applying the method according to claim 13,
producing hydrocarbons from the region.

15. A non-volatile computer readable medium having stored thereon a
computer program product for the estimation of a value for at least an investigated parameter of a hydrocarbon-producing region, said region being describable by a plurality of descriptive parameters, wherein the computer program product comprises instructions causing a programmable machine to execute steps of
a) using a design of experiments tool to determine a ruling law for a match parameter as a function of said plurality of descriptive parameters, based on a set of experiments conducted for a selected group of sets of values for said plurality of descriptive parameters,
b) conducting said set of experiments using a simulation tool wherein, for each set of values of the selected group, the region is geometrically and physically modelled, and a value for said match parameter for this group is estimated with the simulation tool,
c) determining suitable sets of values for said plurality of descriptive parameters from the ruling law, and
d) determining said value for at least an investigated parameter from said suitable sets of values, when the computer program product is loaded in the programmable machine.

16. The non-volatile computer readable medium as claimed in claim 15, wherein step d) comprises conducting an experiment using said simulation tool for at least one of said suitable sets of values, and determining said value for at least an investigated parameter as a result of said experiment.

17. The non-volatile computer readable medium as claimed in claim 15, wherein said investigated parameter is a level of an uncertainty of another parameter, wherein step d) comprises estimating said level of uncertainty based on a dispersion of said suitable sets of values.

18. The non-volatile computer readable medium as claimed in claim 15, wherein at step a), screening intervals are defined for each descriptive parameter, and wherein said group is selected inside these intervals.

19. The non-volatile computer readable medium as claimed in claim 18, wherein the computer program product further comprises instructions to cause the programmable machine to perform at least once modifying the intervals, and repeating steps a) and b) for modified intervals, when the computer program product is loaded in the programmable machine.

20. The non-volatile computer readable medium as claimed in claim 18, wherein discrete values are listed in each interval, and wherein, at step c), said ruling law is applied to an exhaustive combination of these discrete values.

21. The non-volatile computer readable medium as claimed in claim 18, wherein at least some of said intervals are determined at least based on at least one of the following inputs:
petrophysical data for the region,
micro-seismic data for the region,
dynamic data for the region.

22. The non-volatile computer readable medium as claimed in claim 15, wherein, at step c), suitable sets of values are determined by comparing measured or predictive data for the region to estimations of values obtained from the ruling law.

23. The non-volatile computer readable medium as claimed in claim 15, wherein the descriptive parameters comprise natural and engineered parameters of the region.

24. The non-volatile computer readable medium as claimed in claim 15, wherein the hydrocarbon-producing region is a shale hydrocarbon reservoir (3b) comprising the three following zones:
propped fractures,
an outer Unstimulated Rock Volume,
an internal Effective Stimulated Rock Volume, comprising unpropped or slightly propped network fractures,
and wherein the unstimulated Rock Volume is modelled at step b).

25. The non-volatile computer readable medium as claimed in claim 24, wherein the descriptive parameters include the storativity, conductivity and permeability impairment with overburden pressure of each zone, and exchange capacities between the respective zones.

26. The non-volatile computer readable medium as claimed in claim 25, wherein descriptive parameters are chosen among:
a surface area of the propped fractures,
a permeability of the propped fractures,
a volume of the Effective Stimulated Rock Volume,
a permeability of matrix in the Effective Stimulated and Unstimulated Rock Volume,
a permeability of fractures in the Effective Stimulated Rock Volume,
a density of fractures in the Effective Stimulated Rock Volume,
a volume of the Unstimulated Rock Volume,
a storativity of the adsorbed gas,
dynamics of the diffusion/adsorption,
a network fracture permeability response to variations of overburden pressure,
a propped fracture permeability response to variations of overburden pressure,
or combinations of these parameters.

27. A non-volatile computer readable medium having stored thereon a computer program product for the planning of the operation of a hydrocarbon-producing region, wherein the computer program product comprises instructions causing a programmable machine to execute steps of
a)using a design of experiments tool to determine a ruling law (f) for a match parameter as a function of said plurality of descriptive parameters, based on a set of experiments conducted for a selected group of sets of values for said plurality of descriptive parameters,
b) conducting said set of experiments using a simulation tool wherein, for each set of values of the selected group, the region is geometrically and physically modelled, and a value for said match parameter for this group is estimated with the simulation tool,
c) determining suitable sets of values for said plurality of descriptive parameters from the ruling law,
d) determining said value for at least an investigated parameter from said suitable sets of values,
and generating a reservoir model of the region, when the computer program product is loaded in the programmable machine.
